(19) United States
(12) Patent Application Publication
(10) Pub. No.: US 2007/0120427 A1
(43) Pub. Date: May 31, 2007

(54) Electric machine having a liquid-cooled rotor

(75) Inventors: Trevor Iund, Peoria, IL (US); Roy Wookey, Canton, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/289,305

(22) Filed: Nov. 30, 2005

(51) Int. Cl. H02K 9/00; H02K 9/20

(52) U.S. Cl. 310/54; 310/52; 310/112; 310/61

(57) ABSTRACT

An electric machine for a work machine is disclosed. The electric machine has a housing with at least one fluid passageway, a stator fixedly disposed within the housing, and a rotor rotatingly disposed radially inward from the stator. The rotor has a first axial bore, a first radial passageway, a second axial bore, and a second radial passageway. The first axial bore is in fluid communication with the at least one fluid passageway of the housing. The first radial passageway is in fluid communication with the first axial bore and configured to communicate fluid from the first axial bore with the stator. The second axial bore is in fluid communication with the at least one fluid passageway of the housing. The second radial passageway is in fluid communication with the second axial bore and configured to communicate fluid from the second axial bore with the stator.

### TECHNICAL FIELD

The present disclosure relates generally to an electric machine and, more particularly, to an electric machine having a liquid-cooled rotor.

### BACKGROUND

Electric machines such as, for example, motors and generators may be used to generate mechanical power in response to an electrical input or to generate electrical power in response to a mechanical input. Magnetic, resistive, and mechanical losses within the motors and generators during mechanical and electrical power generation can cause a build up of heat, which may be dissipated to avoid malfunction and/or failure of the electric machine. One of the limitations on the power output of the electric machines may be the capacity of the electric machine to dissipate this heat.

One method of dissipating heat within an electric machine includes directing a cooling medium into the electric machine via a rotor. For example, U.S. Pat. No. 5,019,733 (the '733 patent) to Kano et al. teaches an excitation-type AC generator having stator and field coils cooled by a fluid passing through passageways within a rotating shaft. Specifically, during circulation, the fluid is directed axially into one end of a rotor shaft and then outward via radially-bored passageways to spray the fluid onto the stator and field coils, thereby removing heat from the generator.

Although the radially-bored passageways of the rotor shaft may facilitate some heat removal from portions of the generator, they may remove too little heat, and the removal of heat may be disproportionate. In particular, because the cooling fluid enters the rotor shaft from only one end and then is immediately redirected away from the rotor, it may be ineffective for removing substantial amounts of heat from the rotor. In addition, because little or no heat is removed from the other end of the rotor, the distribution of heat along the rotor may be disproportionate, possibly resulting in damage to components of the generator.

The disclosed electric machine is directed to overcoming one or more of the problems set forth above.

### SUMMARY OF THE INVENTION

In one aspect, the present disclosure is directed to an electric machine that includes a housing having at least one fluid passageway, a stator fixedly disposed within the housing, and a rotor rotatingly disposed radially inward from the stator. The rotor includes a first axial bore, a first radial passageway, a second axial bore, and a second radial passageway. The first axial bore is in fluid communication with the at least one fluid passageway of the housing. The first radial passageway is in fluid communication with the first axial bore and configured to communicate fluid from the first axial bore with the stator. The second axial bore is in fluid communication with the at least one fluid passageway of the housing. The second radial passageway is in fluid communication with the second axial bore and configured to communicate fluid from the second axial bore with the stator.

In another aspect, the present disclosure is directed to an electric machine including a housing having at least one fluid passageway, a stator fixedly disposed within the housing, and a rotor rotatingly disposed radially inward from the stator. The rotor includes an axial bore, a rotor end ring, and a first radial passageway. The axial bore is in fluid communication with the at least one passageway of the housing. The rotor end ring has an interior annular channel, and the first radial passageway is in fluid communication with the axial bore and the interior annular channel. The first radial passageway is configured to communicate fluid from the axial bore with the stator via the interior annular channel.

In yet another aspect, the present disclosure is directed to a method of operating an electric machine. The method includes rotating a rotor disposed radially inward of a stator. The method also includes directing fluid into the electric machine through a housing external to the stator, directing fluid from the housing axially into a first end of the rotor and a second end of the rotor, and directing fluid from the first and second ends of the rotor radially outward to the stator via axially spaced apart first and second passageways.

In yet another aspect, the present disclosure is directed to a method of operating an electric machine. The method includes rotating a rotor disposed radially inward of a stator. The method also includes directing fluid into the electric machine through a housing external to the stator, directing fluid from the housing axially into an end of the rotor, directing fluid from the end of the rotor radially outward to an interior annular channel of a rotor end ring via a first passageway, and directing fluid from the interior annular channel to the stator.

### BRIEF DESCRIPTION OF THE DRAWINGS

FIG. 1 is a diagrammatic illustration of an exemplary disclosed work machine; and

FIG. 2 is a cutaway-view illustration of an electric machine for the work machine of FIG. 1.

### DETAILED DESCRIPTION

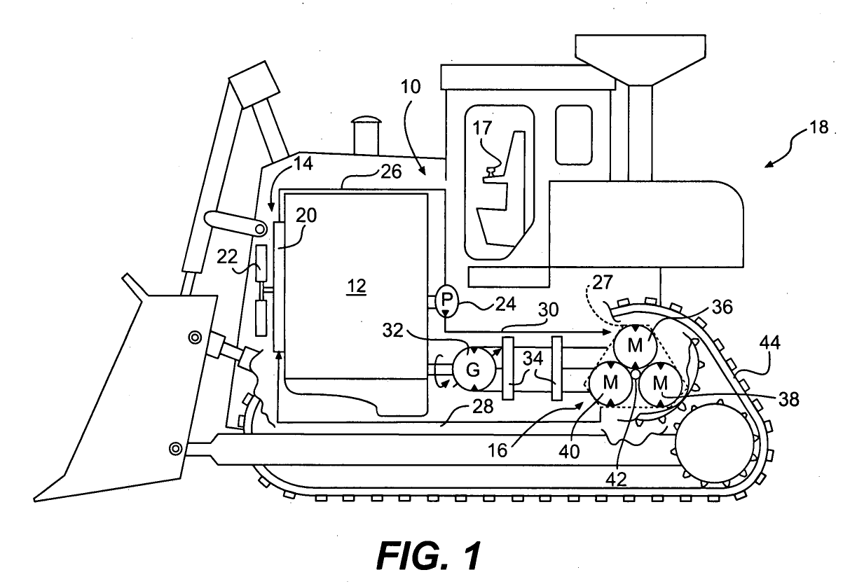

FIG. 1 illustrates an exemplary power system 10 having a power source 12, a cooling system 14, and an electric machine 16. Power system 10 may form a portion of a mobile work machine 18 such as, for example, a dozer, an articulated truck, an excavator, or any other mobile work machine known in the art, with electric machine 16 functioning as the main propulsion unit of work machine 18. It is contemplated that electric machine 16 may alternatively function as the main electrical power-generating unit of work machine 18. It is also contemplated that power system 10 may alternatively form a portion of a stationary work machine such as a generator set, a pump, or any other suitable stationary work machine.

Power source 12 may be configured to produce a rotational mechanical power output and may include a combustion engine. For example, power source 12 may include a diesel engine, a gasoline engine, a gaseous fuel-powered engine, or any other type of combustion engine apparent to one skilled in the art. It is also contemplated that power source 12 may alternatively embody a non-combustion source of power such as a fuel cell, a battery, or any other source of power known in the art.

Cooling system 14 may embody a pressurized system configured to transfer heat to or from power source 12 and/or electric machine 16. Cooling system 14 may include, among other things, a heat exchanger 20, a fan 22, and a source 24 configured to pressurize a heat-transferring medium.

Heat exchanger 20 may embody a liquid-to-air heat exchanger configured to facilitate the transfer of heat to or from the heat-transferring medium. For example, heat exchanger 20 may include a tube and fin-type heat exchanger, a tube and shell-type heat exchanger, a plate-type heat exchanger, or any other type of heat exchanger known in the art. Heat exchanger 20 may be connected to source 24 via a supply conduit 26, and to a housing 27 of electric machine 16 via a return conduit 28. It is contemplated that heat exchanger 20 may function as the main radiator of power source 12, the engine oil cooler, the transmission oil cooler, the brake oil cooler, or any other cooling component of power source 12. It is further contemplated that heat exchanger 20 may alternatively be dedicated to conditioning only the heat-transferring medium supplied to electric machine 16.

Fan 22 may be disposed proximal to heat exchanger 20 and configured to produce a flow of air across heat exchanger 20 for liquid-to-air heat transfer. It is contemplated that fan 22 may be omitted or remotely located, if desired, and a secondary fluid circuit (not shown) may connect to heat exchanger 20 to transfer heat to or from the heat-transferring medium via liquid-to-liquid heat transfer.

Source 24 may embody any device for pressurizing the heat-transferring medium within cooling system 14. For example, source 24 may include a fixed displacement pump, a variable displacement pump, a variable flow pump, or any other type of pump known in the art. Source 24 may be disposed between heat exchanger 20 and electric machine 16, and driven hydraulically, mechanically, or electrically by power source 12. It is contemplated that source 24 may alternatively be located remotely from power source 12 and driven by a means other than power source 12. It is also contemplated that source 24 may be dedicated to pressurizing only the heat-transferring medium directed to electric machine 16. Source 24 may be connected to housing 27 by way of a supply conduit 30.

The heat-transferring medium may be a low-pressure fluid or a high-pressure fluid. Low-pressures fluids may include, for example, water, glycol, a water-glycol mixture, a blended air mixture, a power source oil such as transmission oil, engine oil, brake oil, diesel fuel, or any other low-pressure fluid known in the art for transferring heat. High-pressure fluids may include, for example, R-134, propane, nitrogen, helium, or any other high-pressure fluid known in the art.

Electric machine 16 may be electrically coupled to power source 12 by way of a generator 32 and power electronics 34. In particular, generator 32 may be drivably connected to power source 12 via a flywheel (not shown), a spring or hydraulic coupling (not shown), a planetary gear arrangement (not shown), or in any other suitable manner. Generator 32 may be connected to power source 12 such that a mechanical output rotation of power source 12 results in a corresponding electrical output directed via power electronics 34 to electric machine 16.

Electric machine 16 may include multiple components that interact to produce mechanical power in response to an electrical input. Specifically, electric machine 16 may include a first motor 36, a second motor 38, and a third motor 40 disposed within housing 27 and operatively coupled to an output shaft 42. As electrical power is supplied from generator 32 to electric machine 16, first, second, and third motors 36-40 may apply a torque to output shaft 42 at a range of rotational speeds. Output shaft 42 may be connected to a traction device 44 of work machine 18, thereby propelling work machine 18 in response to the applied torque. It is contemplated that rather than producing a mechanical output in response to an electrical input, electric machine 16 may alternatively produce electrical power in response to a mechanical input.

Output shaft 42 may embody a cylindrical coupling member for transferring power into and/or out of electric machine 16. Output shaft 42 may extend from one end of housing 27 to an opposing end of housing 27. It is also contemplated that output shaft 42 may protrude from both ends or only one end of housing 27 and/or that multiple shafts may be included within electric machine 16 and interconnected by means of a gear arrangement.

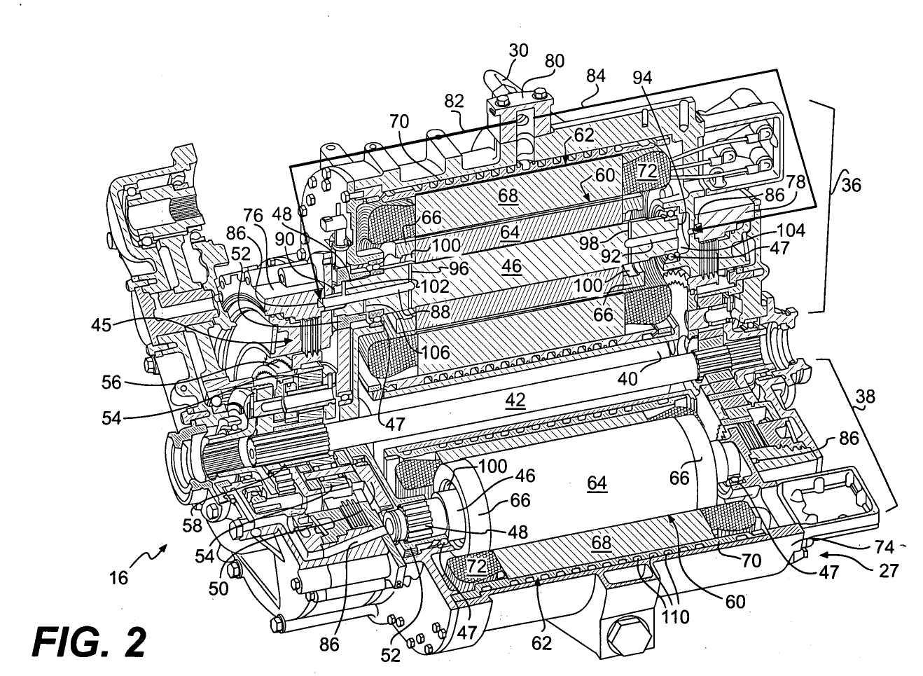

As illustrated in FIG. 2, first, second, and third motors 36-40 may be radially arranged about output shaft 42 and coupled to output shaft 42 by way of a gear arrangement 45. In particular, each of motors 36-40 may include a rotor shaft 46 rotatably supported within housing 27 by one or more bearings 47, and having external splines 48. Together, the rotor shafts 46 of each of motors 36-40 may function to simultaneously rotate a driven gear member 50 by way of a plurality of spur gears 52. That is, external splines 48 may engage internal splines of spur gears 52, while external gear teeth of spur gears 52 may mesh with external gear teeth of driven gear member 50. Driven gear member 50 may then, in turn be operatively connected to output shaft 42 such that output shaft 42 may rotate in correspondence with an input rotation of rotor shafts 46.

Gear arrangement 45 may receive an input rotation via rotor shafts 46 and/or one or more other gear members (not shown) of gear arrangement 45, and generate a corresponding output rotation of output shaft 42. Alternatively, gear arrangement 45 may receive an input rotation via output shaft 42 and correspondingly rotate rotor shafts 46 to generate an electrical output. Multiple input and output combinations may be possible.

Each of motors 36-40 may include components that interact to rotate rotor shafts 46 in response to an electrical input. In particular, each machine may include a rotor assembly 60 and a stator assembly 62. It is contemplated that motors 36-40 may contain additional or different components such as, for example, control systems, processors, power electronics, one or more sensors, power storage devices, and/or other components known in the art.

Rotor assembly 60 may include a stack of steel laminations 64 having multiple protruding portions, also known as rotor teeth. The rotor teeth may be interconnected by way of one or more end rings 66 and configured to interact with an electrically-induced magnetic field within electric machine 16 to cause a rotation of rotor shaft 46. Laminations 64 may be fastened to rotor shaft 46 by, for example, interference fit, welding, threaded fastening, chemical bonding, or in any other appropriate manner. As each protruding portion interacts with the magnetic field, a torque may be produced that rotates rotor shaft 46.

Stator assembly 62 may include components fixed to housing 27 that are configured to produce the electrically-induced magnetic field described above. Specifically, stator assembly 62 may include laminations of steel 68 having protruding portions, also known as stator teeth, that extend inward from an iron sleeve 70, and windings 72 of copper wire wrapped around and epoxied to each protruding portion of laminations 68 to form a plurality of poles. As electrical current is sequentially applied to windings 72, a rotating magnetic field may be generated through the plurality of poles.

As described above, motors 36-40 may be contained within a single common housing 27. Housing 27 may be configured to house the rotor assemblies 60, stator assemblies 62, and bearings 47 associated with motors 36-40. In particular, housing 27 may include an outer shell 74, a first end cap 76, and a second end cap 78. Outer shell 74 may annularly enclose rotor and stator assemblies 60, 62, and connect to first and second end caps 76, 78. First and second end caps 76, 78 may support bearings 47 and may each include a centrally-located through-hole that allows the extension of rotor shaft 46 through housing 27. It is contemplated that one or both of first and second end caps 76, 78 may be integral with outer shell 74, if desired.

As also illustrated in FIG. 2, electric machine 16 may include an internal cooling circuit to direct the heat-transferring medium throughout or near the heat-generating components of electric machine 16. Specifically, the heat-transferring medium may enter housing 27 via a distribution block 80, proceed via a first passageway 82 to first end cap 76, and via a second passageway 84 to second end cap 78. First and second passageways 82, 84 may be internal passageways within outer shell 74 or may alternatively embody external tubing. After entering first and second end caps 76, 78, the heat-transferring medium may be directed annularly to rotor shaft 46 of each of motors 36-40 via an annular channel 86 located within each of first and second end caps 76, 78.

From annular channels 86, the heat-transferring medium may be simultaneously directed into each rotor shaft 46 by way of axial passageways, and then redirected radially outward. Specifically, rotor shaft 46 may include a first axial bore 88 recessed within a first end surface 90 a blind depth, and a second axial bore 92 recessed within a second opposing end surface 94 a blind depth. The bore diameters and blind depths of first and second axial bores 88, 92 may or may not be equal. The heat-transferring medium may flow into rotor shaft 46 via first and second axial bores 88, 92, and then radially outward via first and second sets of radial passageways 96, 98. Radial passageways 96, 98 may extend outward from first and second axial bores, respectively, to an outer surface of rotor shaft 46.

Upon exiting rotor shaft 46 via first and second sets of radial passageways 96, 98, the heat-transferring medium may flow toward stator assembly 62 by way of end rings 66. In particular, because of the rotating forces associated with rotor shaft 46 and the pressure induced by source 24 (referring to FIG. 1), the heat-transferring medium may be sprayed radially outward from rotor shaft 46 into an interior annular channel 100 located within each end ring 66. Interior annular channels 100 may help to retain the heat-transferring medium against rotor assembly 60 for maximum heat transfer. Once end rings 66 are filled with the heat-transferring medium, the medium may spill out of interior annular channels 100, across the face of end rings 66, and toward stator assembly 62. After spraying on the components of stator assembly 62 for additional heat transfer, the heat-transferring medium may be pulled by gravity toward a sump (not shown) connected to housing 27, where the heat-transferring medium may collect for return to heat exchanger 20.

In addition to transferring heat with electric machine 16, the heat-transferring medium may also lubricate portions of electric machine 16. In particular, an additional radial passageway 106 within rotor shaft 46 may direct the heat-transferring medium from first axial bore 88 to bearing 47 located toward first end surface 90. After forcing the heat-transferring medium from one side of bearing 47 through bearing 47 to an opposing side, thereby lubricating bearing 47, the heat-transferring medium may combine with the fluid exiting interior annular channels 86 to transfer heat with stator assembly 62. Bearing 47 located toward second end surface 92 may be lubricated by the heat-transferring medium before the medium enters second axial bore 92 by way of a lubrication chamber 104 located in second end cap 78. Another radial passageway 102 within rotor shaft 46 may direct the heat-transferring medium from first axial bore 88 to the splined connection between rotor shaft 46 and spur gear 52 and to the external teeth of spur gear 52 for lubrication purposes.

In addition to directing the heat-transferring medium through electric machine 16, external annular heat transfer from stator assembly 62 may be provided by way of iron sleeve 70. In particular, iron sleeve 70 may include one or more annular grooves 110 located in an outer surface of iron sleeve 70 that, together with an inner annular surface of outer shell 74, may form annular fluid passageways. The heat-transferring medium may enter annular grooves 110 by way of distribution block 80 and, after transferring heat with the external annular surface of stator assembly 62, may drain to the sump. It is also contemplated that iron sleeve 70 may be omitted, if desired, or retained and annular grooves 110 omitted.

### INDUSTRIAL APPLICABILITY

The disclosed electric machine finds potential application in any power system where it is desirable to dissipate substantial amounts of heat from an electric machine in a controlled and uniform manner. The disclosed electric machine finds particular applicability in vehicle drive systems. However, one skilled in the art will recognize that the disclosed electric machine could be utilized in relation to other drive systems that may or may not be associated with a vehicle. The heat-transferring operation of electric machine 16 will now be described.

Referring to FIG. 1, when power system 10 is in operation, the heat-transferring medium, conditioned (heated or cooled) by heat exchanger 20, may be pumped by source 24 through power source 12 and/or electric machine 16. As the heat-transferring medium courses through power source 12 and/or electric machine 16, heat may be continuously transferred to or from power source 12 and/or electric machine 16. Upon exiting electric machine 16, the flow of the heat-transferring medium from electric machine 16 may be directed to rejoin the flow of the heat-transferring medium exiting power source 12 where both flows may then be routed through heat exchanger 20 to either expel heat or absorb heat during a conditioning process.

As the flow of the heat-transferring medium enters electric machine 16 by way of distribution block 80 (referring to FIG. 2), it may first be directed via first and second passageways 82, 84 to first and second end caps 76, 78 where the flow may then be directed radially inward to first and second axial bores 88, 92 of rotor shaft 46. Upon entering first and second axial bores 88, 92, the flow may be sprayed radially outward via the radial passageways 96, 98, 102, 106.

After exiting radial passageways 96, 98, 102, 106, the heat-transferring medium may fill interior annular channels 100 and spill over end rings 66 toward stator assembly 62, lubricate bearing 47 located toward first end surface 90, and lubricate the splined engagement between rotor shaft 46 and spur gear 52 and the external gear teeth of spur gear 52. The heat-transferring medium may then drain to the sump for recirculation through heat exchanger 20 (referring to FIG. 1) via return conduit 28.

In addition to directing the heat-transferring medium through rotor shaft 46 to transfer heat with rotor assembly 60 and internal surfaces of stator assembly 62, the heat-transferring medium may be directed to transfer heat with the external annular surface of stator assembly 62. In particular, the heat-transferring medium may be simultaneously directed through annular grooves 110 of iron sleeve 70 to transfer heat with the outer surfaces of windings 72 and the protruding portions of stator assembly 62.

Greater cooling efficiency of electric machine 16 may be realized because the heat-transferring medium is directed evenly to components within electric machine 16 that tend to generate the greatest amount of heat. Specifically, because the heat-transferring medium is directed to both ends of rotor shaft 46 and to stator assembly 62, a greater amount of heat may be transferred than if the fluid only contacted a single end of rotor shaft 46 and/or never removed heat from stator assembly 62. Further, because the heat-transferring medium transfers heat evenly with electric machine 16 (e.g., with opposing ends of rotor shaft 46, rather than only a single end), the heat-induced stresses experienced by the components of electric machine 16 may be reduced, as compared to disproportionate heat transfer.

Additional advantages may be realized because the fluid passageways of electric machine 16 direct the heat-transferring medium both within and around stator assembly 62. In particular, transferring heat with both inner and outer surfaces of stator assembly 62 may increase the heat-transferring capacity of electric machine 16 as compared to only transferring heat with one of the inner or outer surfaces of stator assembly 62.

It will be apparent to those skilled in the art that various modifications and variations can be made to the electric machine of the present disclosure. Other embodiments of the electric machine will be apparent to those skilled in the art from consideration of the specification and practice of the electric machine disclosed herein. It is intended that the specification and examples be considered as exemplary only, with a true scope of the disclosure being indicated by the following claims and their equivalents.

What is claimed is:

1. An electric machine, comprising:
a housing having at least one fluid passageway;
a stator fixedly disposed within the housing; and
a rotor rotatingly disposed radially inward from the stator and having:
a first axial bore in fluid communication with the at least one fluid passageway of the housing;
a first radial passageway in fluid communication with the first axial bore and configured to communicate fluid from the first axial bore with the stator;
a second axial bore in fluid communication with the at least one fluid passageway of the housing; and
a second radial passageway in fluid communication with the second axial bore and configured to communicate fluid from the second axial bore with the stator.

2. The electric machine of claim 1, wherein each of the first and second axial bores are blind and located in opposing ends of the rotor.

3. The electric machine of claim 2, further including:
a first rotor end ring having an interior annular channel; and
a second rotor end ring having an interior annular channel,
wherein the first and second radial passageways are configured to communicate fluid from the first and second axial bores with the stator via the interior annular channels.

4. The electric machine of claim 1, further including:
a bearing disposed within the housing and configured to support rotation of the rotor; and
a third radial passageway axially spaced apart from the first and second radial passageways and configured to communicate fluid from one of the first and second axial bores with the bearing.

5. The electric machine of claim 4, wherein the fluid communicated with the bearing is thereafter directed toward the stator.

6. The electric machine of claim 5, further including:
a gear operatively connected to the rotor; and
a fourth radial passageway axially spaced apart from the first, second, and third radial passageways and configured to communicate fluid from one of the first and second axial bores with the gear.

7. The electric machine of claim 1, further including:
a cooling sleeve disposed around the stator; and
a distribution block configured to distribute cooling fluid to the cooling sleeve and to the at least one fluid passageway of the housing.

8. The electric machine of claim 1, wherein:
the stator is a first stator;
the rotor is a first rotor; and
the electric machine further includes:
at least a second stator substantially identical to the first stator and fixedly disposed within the housing; and
a second rotor rotatingly disposed radially inward from the at least a second stator, the second rotor being substantially identical to the first rotor and configured to receive fluid from the at least one fluid passageway in parallel to the first rotor.

9. An electric machine, comprising:
a housing having at least one fluid passageway;
a stator fixedly disposed within the housing; and
a rotor rotatingly disposed radially inward from the stator and having:
an axial bore in fluid communication with the at least one passageway of the housing;
a rotor end ring having an interior annular channel; and
a first radial passageway in fluid communication with the axial bore and the interior annular channel, the first radial passageway configured to communicate fluid from the axial bore with the stator via the interior annular channel.

10. The electric machine of claim 9, further including:
a bearing disposed within the housing and configured to support rotation of the rotor; and
a second radial passageway axially spaced apart from the first radial passageway and configured to communicate fluid from the axial bore with the bearing.

11. The electric machine of claim 10, further including:
a gear operatively connected to the rotor; and
a third radial passageway axially spaced apart from the first and second radial passageways and configured to communicate fluid from the axial bore with the gear.

12. The electric machine of claim 9, further including:
a cooling sleeve disposed around the stator; and
a distribution block configured to distribute cooling fluid to the cooling sleeve and to the at least one fluid passageway of the housing.

13. The electric machine of claim 9, wherein the axial bore has a blind depth.

14. The electric machine of claim 9, wherein:
the stator is a first stator;
the rotor is a first rotor; and
the electric machine further includes:
at least a second stator substantially identical to the first stator and fixedly disposed within the housing; and
a second rotor rotatingly disposed radially inward from the at least a second stator, the second rotor being substantially identical to the first rotor and configured to receive fluid from the at least one fluid passageway in parallel to the first rotor.

15. A method of operating an electric machine, comprising:
rotating a rotor disposed radially inward of a stator;
directing fluid into the electric machine through a housing external to the stator;
directing fluid from the housing axially into a first end of the rotor and a second end of the rotor; and
directing fluid from the first and second ends of the rotor radially outward to the stator via axially spaced apart first and second passageways.

16. The method of claim 15, wherein directing fluid from the first and second ends of the rotor radially outward includes directing the fluid into annular channels disposed within a pair of opposing rotor end rings.

17. The method of claim 15, further including directing the fluid from at least the first end of the rotor radially outward via a third passageway axially spaced apart from the first and second passageways to lubricate a bearing.

18. The method of claim 17, further including:
introducing the fluid to a first side of the bearing from the third passageway; and
directing the fluid from a second side of the bearing to the stator.

19. The method of claim 18, further including directing the fluid from at least one of the first and second ends of the rotor radially outward to a gear via a fourth passageway axially spaced apart from the first, second, and third passageways.

20. The method of claim 15, further including directing fluid from the housing to a cooling sleeve disposed around the stator.

21. The method of claim 15, wherein:
the rotor is a first rotor;
the stator is a first stator; and
the method further includes:
rotating a second rotor disposed radially inward of a second stator; and
directing from the housing axially into a first and a second end of the second rotor in parallel to the first and second ends of the first rotor.

22. A method of operating an electric machine, comprising:
rotating a rotor disposed radially inward of a stator;
directing fluid into the electric machine through a housing external to the stator;
directing fluid from the housing axially into an end of the rotor;
directing fluid from the end of the rotor radially outward to an interior annular channel of a rotor end ring via a first passageway; and
directing fluid from the interior annular channel to the stator.

23. The method of claim 22, further including directing the fluid from the end of the rotor radially outward via a second passageway axially spaced apart from the first passageway to lubricate a bearing.

24. The method of claim 23, further including:
introducing the fluid to a first side of the bearing from the second passageway; and
directing the fluid from a second side of the bearing to the stator.

25. The method of claim 23, further including directing the fluid from the end of the rotor radially outward to a gear via a third passageway axially spaced apart from the first and second passageways.

26. The method of claim 22, further including directing fluid from the housing to a cooling sleeve disposed around the stator.

27. The method of claim 22, wherein:
the rotor is a first rotor;
the stator is a first stator; and
the method further includes:
rotating a second rotor disposed radially inward of a second stator; and
directing fluid from the housing into an end of the second rotor in parallel with the end of the first rotor.

28. A work machine, comprising:
a power source operable to generate a power output;
a cooling system operable to cool the power source; and
an electric machine operable to receive the power output, to generate a corresponding output, and to receive cooling fluid from the cooling system, the electric machine including:
a housing with at least one fluid passageway;
a stator fixedly disposed within the housing; and
a rotor rotatingly disposed radially inward from the stator and having:
a first blind axial bore located in a first end of the rotor and being in fluid communication with the at least one fluid passageway of the housing;
a first radial passageway in fluid communication with the first axial bore and configured to communicate fluid from the first axial bore with the stator;
a second blind axial bore located in a second end of the rotor and being in fluid communication with the at least one fluid passageway of the housing;
a second radial passageway in fluid communication with the second axial bore and configured to communicate fluid from the second axial bore with the stator;
a first rotor end ring having an interior annular channel; and
a second rotor end ring having an interior annular channel,
wherein the first and second radial passageways are configured to communicate fluid from the first and second axial bores with the stator via the interior annular channels.

29. The work machine of claim 28, further including:
a bearing disposed within the housing and configured to support rotation of the rotor;
a third radial passageway axially spaced apart from the first and second radial passageways and configured to communicate fluid from one of the first and second axial bores with the bearing;
a gear operatively connected to the rotor; and
a fourth radial passageway axially spaced apart from the first, second, and third radial passageways and configured to communicate fluid from one of the first and second axial bores with the gear.

30. The work machine of claim 28, further including:
a cooling sleeve disposed around the stator; and
a distribution block configured to distribute cooling fluid to the cooling sleeve and to the at least one fluid passageway of the housing.

31. The work machine of claim 28, wherein:
the stator is a first stator;
the rotor is a first rotor; and
the electric machine further includes:
a second stator substantially identical to the first stator and fixedly disposed within the housing;
a second rotor rotatingly disposed radially inward from the second stator, the second rotor being substantially identical to the first rotor and configured to receive fluid from the at least one fluid passageway in parallel to the first rotor;
a third stator substantially identical to the first and second stators and fixedly disposed within the housing; and
a third rotor rotatingly disposed radially inward from the third stator, the third rotor being substantially identical to the first and second rotors and configured to receive fluid from the at least one fluid passageway in parallel to the first and second rotors.
